(19) United States
(12) Patent Application Publication
(10) Pub. No.: US 2024/0386545 A1
(43) Pub. Date: Nov. 21, 2024

(54) COMPUTER-IMPLEMENTED SYSTEM AND METHOD FOR DETECTING PRESENCE AND INTACTNESS OF A CONTAINER SEAL

(71) Applicant: ATAI LABS PRIVATE LIMITED, Hyderabad (IN)

(72) Inventors: SHIVA KUMAR PATWARI, ZAHEERABAD (IN); KRISHNA KISHORE ANDHAVARAPU, HYDERABAD (IN); SATISH CHANDRA GUNDA, KURNOOL (IN); KISHOR ARUMILLI, HYDERABAD (IN); GANGADHAR GUDE, HYDERABAD (IN)

(21) Appl. No.: 18/691,988

(22) PCT Filed: Sep. 12, 2022
(86) PCT No.: PCT/IB2022/058579

§ 371 Date: Mar. 14, 2024

(30) Foreign Application Priority Data
Sep. 15, 2021 (IN) 202141041657

(51) Int. Cl. G06T 7/00; G06T 7/207; G06T 7/246

(52) U.S. Cl. CPC G06T 7/0008; G06T 7/207; G06T 7/248; G06T 2207/30252

(57) ABSTRACT

Exemplary embodiments of present disclosure directed towards motion detection module configured to receive third camera feed to detect motion of vehicle. Motion detection module configured to compare selected region of interest from consecutive frames of third camera to detect motion using frame difference. Pre-processing module configured to save consecutive frames from first and second camera when vehicle starts crossing third camera. Lock detection module configured to receive saved frames and detects locks present in saved frames of first and second camera. Seal classification module configured to receive lock images from lock detection module and classifies lock images to identify whether locks are sealed, seal classification module configured to determine seal intactness, color of seals using attention maps and computer vision methods, seal information is passed to post-processing module and is configured to track each seal separately thereby generating final output by considering averaged result over lock images.

### TECHNICAL FIELD

The disclosed subject matter relates generally to a tamper resistant container including a tamper-resistant seal. More particularly, the present disclosure relates to a system and method for detecting the presence and intactness of seals on a container.

### BACKGROUND

In the shipping industry, there is a need for security and logistics control to track shipping containers. In particular, shipping containers are sealed at one location after they are loaded with cargo and then transported to another location where the cargo is unloaded. The container seal is positioned on to a container lock. The container seal plays a very important role in the transportation of the shipping container. The container seals are difficult to unlock by an unauthorized party to take items from the shipping container or place harmful items into the container. The only way to remove the seal is by cutting them thereby ensuring it is removed only by the receiver at the destination.

The container seals are positioned on the shipping containers after a shipment is loaded at their respective places such as industry or warehouses. The container seal is meant to stay on throughout the container's final destination and is removed by the consignee. Once the container enters the container depot at the entrance, a number of seals are verified using the information provided by a sender at the source location. This process is done generally by a manual surveyor. Hence, there is a need to develop a system to automate the annual survey process by detecting and counting the number of seals and their intactness using computer vision-based methods and neural networks.

In the light of the aforementioned discussion, there exists a need for a system for detecting presence and intactness of container seals.

### SUMMARY

The following presents a simplified summary of the disclosure in order to provide a basic understanding of the reader. This summary is not an extensive overview of the disclosure and it does not identify key/critical elements of the invention or delineate the scope of the invention. Its sole purpose is to present some concepts disclosed herein in a simplified form as a prelude to the more detailed description that is presented later.

An objective of the present disclosure directed towards a system that finds seal presence and intactness using computer vision at the entrance and exit of the container yards.

Another objective of the present disclosure directed towards the system that automates manual survey process by detecting and counting the number of seals and their intactness using computer vision-based techniques and neural networks.

Another objective of the present disclosure is directed towards the system that eliminates the difficulty to view the container seals due to glare when the sunlight falls directly on cameras.

Another objective of the present disclosure is directed towards the system that reduces the glare on the lens of the cameras by using a cap which obstructs the unwanted light falling on camera lens or by using wide dynamic range camera.

Another objective of the present disclosure is directed towards the system that detects the number of seals present on the container.

Another objective of the present disclosure is directed towards the system that determines the color of the seal using neural network attention maps.

Another objective of the present disclosure is directed towards the system that uses a Deep Sort tracker to average the results from multiple frames.

Another objective of the present disclosure is directed towards the system that detects seals irrespective of orientation of container on the vehicle.

Another objective of the present disclosure is directed towards the system that eliminates the false positives in motion detection using the post-processing.

In an embodiment of the present disclosure, a first camera, a second camera, and a third camera configured to detect motion of a vehicle and enables to capture a first camera feed, a second camera feed, and a third camera feed, and delivers to a computing device over a network; the computing device comprising a seal detection module configured to detect presence and intactness of one or more seals on a container.

In another embodiment of the present disclosure, a pre-processing module comprising a motion detection module configured to receive the third camera feed as an input to detect the motion of a vehicle.

In another embodiment of the present disclosure, the motion detection module configured to compare a selected region of interest from the one or more consecutive frames of the third camera to detect motion of the vehicle using a frame difference.

In another embodiment of the present disclosure, the pre-processing module configured to save one or more consecutive frames from the first camera and the second camera when the vehicle starts crossing the third camera.

In another embodiment of the present disclosure, the frame difference is computed using one or more computer vision methods, the third camera configured to detect motion of the vehicle, the third camera is positioned perpendicular to the container passing through a vehicle lane, the first camera is positioned front side to the container passing through the vehicle lane and the second camera is positioned rear side to the container passing through the vehicle lane.

In another embodiment of the present disclosure, a lock detection module comprising a visual object detection module configured to receive the one or more saved frames from the pre-processing module as the input and detect one or more locks present in the one or more saved frames of the first camera and the second camera.

In another embodiment of the present disclosure, a seal classification module configured to receive the one or more lock images from the lock detection module as the input and classify the one or more lock images to identify whether the one or more locks are sealed.

In another embodiment of the present disclosure, the seal classification module configured to determine a color of the one or more container seals by extracting an attention region and observing one or more pixel values in the extracted region using the activation map of a classification model and histograms.

In another embodiment of the present disclosure, the seal classification module configured to determine intactness of the one or more container seals by extracting an attention region and observing one or more pixel values in the extracted region.

In another embodiment of the present disclosure, the seal classification module configured to determine the color and the seal intactness from the one or more lock images by generating one or more attention maps, the one or more attention maps are used to obtain better localization of the seal, the seal classification module comprising a computer vision and neural network methods configured to determine the color and the seal intactness on obtaining the exact location of the seal.

In another embodiment of the present disclosure, the seal classification module configured to pass seal information to a post-processing module as a JavaScript Object Notation (json) file with a frame number.

In another embodiment of the present disclosure, the post-processing module configured to receive the JavaScript Object Notation (JSON) files corresponding to the container and tracks at least one seal separately using a DeepSort tracking model thereby generating a final output by considering an averaged result over the one or more lock images.

In another embodiment of the present disclosure, a cloud server configured to receive a final output from the seal detection module over the network and updates the final output obtained by the seal detection module on the cloud server, the final output comprising number of seals identified on the one or more locks of the container.

### BRIEF DESCRIPTION OF THE DRAWINGS

In the following, numerous specific details are set forth to provide a thorough description of various embodiments. Certain embodiments may be practiced without these specific details or with some variations in detail. In some instances, certain features are described in less detail so as not to obscure other aspects. The level of detail associated with each of the elements or features should not be construed to qualify the novelty or importance of one feature over the others.

FIG. 1A, FIG. 1B are example diagrams depicting a sample seal and a seal placed on a container lock, in accordance with one or more exemplary embodiments.

FIG. 1C is an example diagram depicting the arrangement of cameras, in accordance with one or more exemplary embodiments.

FIG. 2A, FIG. 2B, FIG. 2C are example diagrams are depicting a front view of the container, a rear view of the container, and a side view of the container, in accordance with one or more exemplary embodiments.

FIG. 3 is a block diagram representing a system in which aspects of the present disclosure can be implemented. Specifically, FIG. 3 depicts a schematic representation of the system for detecting presence and intactness of container seals, in accordance with one or more exemplary embodiments.

FIG. 4 is an example diagram depicting a schematic representation of a seal detection module, in accordance with one or more exemplary embodiments.

FIG. 5A is an example diagram depicting the lock locations with bounding boxes, in accordance with one or more exemplary embodiments.

FIG. 5B, FIG. 5C are example diagrams depicting the top lock view with and without seal, in accordance with one or more exemplary embodiments.

FIG. 5D, FIG. 5E are example diagrams depicting the bottom lock view with and without seal, in accordance with one or more exemplary embodiments.

FIG. 5F, FIG. 5F, is an example diagram depicting the seal tracking image, in accordance with one or more exemplary embodiments.

FIG. 5G, FIG. 5G, is an example diagram depicting attention map image, in accordance with one or more exemplary embodiments.

FIG. 6 is an example flow diagram depicting a method of the pre-processing module, in accordance with one or more exemplary embodiments.

FIG. 7 is another example of flow diagram depicting a method of the post-processing module, in accordance with one or more exemplary embodiments.

FIG. 8 is another example of flow diagram depicting a method for detecting presence and intactness of one or more seals of a container, in accordance with one or more exemplary embodiments.

FIG. 9 is a block diagram illustrating the details of digital processing system in which various aspects of the present disclosure are operative by execution of appropriate software instructions.

### DETAILED DESCRIPTION OF EXAMPLE EMBODIMENTS

It is to be understood that the present disclosure is not limited in its application to the details of construction and the arrangement of components set forth in the following description or illustrated in the drawings. The present disclosure is capable of other embodiments and of being practiced or of being carried out in various ways. Also, it is to be understood that the phraseology and terminology used herein is for the purpose of description and should not be regarded as limiting.

The use of “including”, “comprising” or “having” and variations thereof herein is meant to encompass the items listed thereafter and equivalents thereof as well as additional items. The terms “a” and “an” herein do not denote a limitation of quantity, but rather denote the presence of at least one of the referenced item. Further, the use of terms “first”, “second”, and “third”, and the like, herein do not denote any order, quantity, or importance, but rather are used to distinguish one element from another.

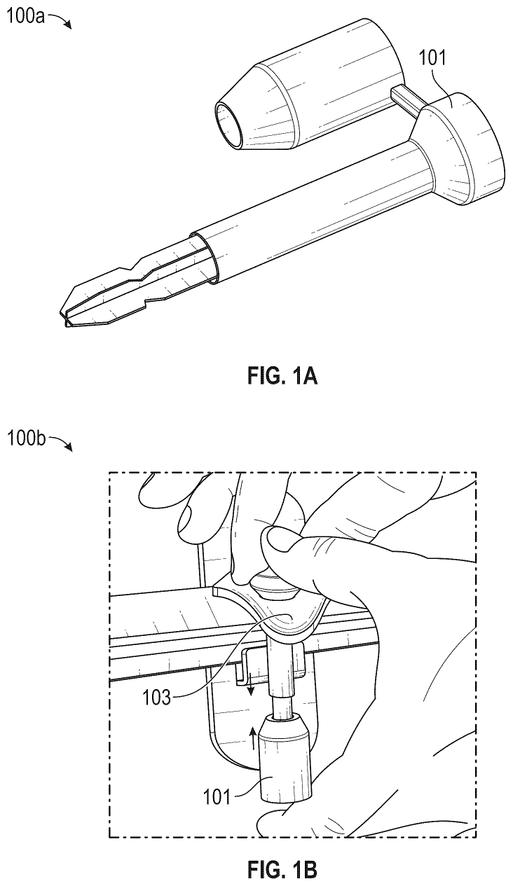

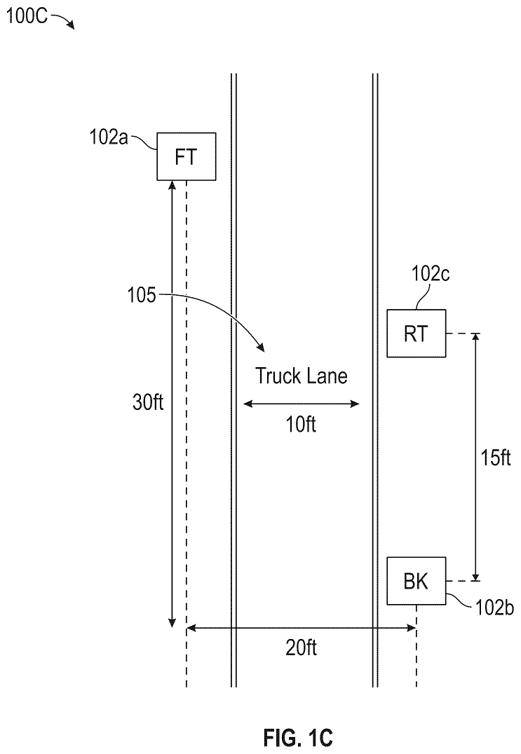

Referring to FIG. 1A, FIG. 1B, FIG. 1A, FIG. 1B are example diagrams 100a and 100b depicting a sample seal and a seal placed on a container lock, in accordance with one or more exemplary embodiments. The diagram 100a depicts a seal 101 and the diagram 100b depicts the seal 101, a lock 103. The seal 101 may be placed on the container lock 103. The seal 101 may include, but not limited to a door seal, a container seal, and so forth.

Referring to FIG. 1C, FIG. 1C is an example diagram 100c depicting the arrangement of cameras, in accordance with one or more exemplary embodiments. The diagram 100c includes a first camera 102a, a second camera 102b and a third camera 102c, and a truck lane 105. The cameras 102a, 102b, 102c may include, but is not limited to, three-dimensional cameras, thermal image cameras, infrared cameras, night vision cameras, varifocal cameras, and the like. The first camera 102a may be represented as a front camera and the second camera 102b may be represented as a rear camera or back camera. The third camera 102c may be represented as a right camera or a side camera. The first camera 102a may be configured to capture the first camera feed. The first camera feed may include, but not limited to, the front view images of the container, and the like. The second camera 102b may be configured to capture the second camera feed. The second camera feed may include, but not limited to, the rear-view images of the container, and the like. The third camera 102c may be configured to capture the third camera feed. The third camera feed may include, but not limited to, the side view images of the container, and the like.

The camera views of the second camera 102b or the first camera 102a are adjusted such that the second camera 102b or the first camera 102a may be configured to view the container seals 101 when the container truck is passing in between the two cameras in the truck lane 105. The third camera 102c may be positioned perpendicular to the container to see the container from the side view. The first camera 102a, the second camera 102b, and the third camera 102c may be positioned at a height where the user may able to view the complete view of the container. For example, the height may be nine feet from the ground. When sunlight falls directly on the cameras 102a, 102b, 102c, it is difficult to see seals due to glare. This may be reduced by using a cap which may obstruct the unwanted light from falling on camera lens or by using wide dynamic range camera.

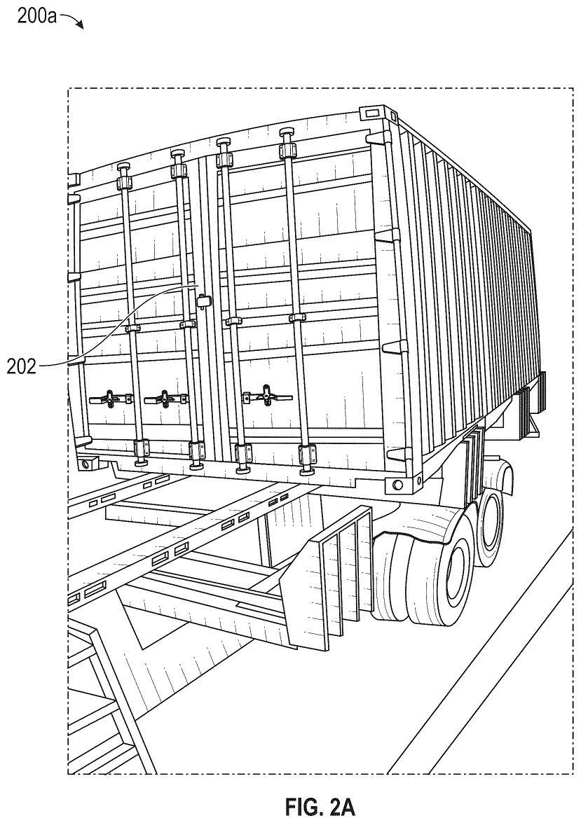

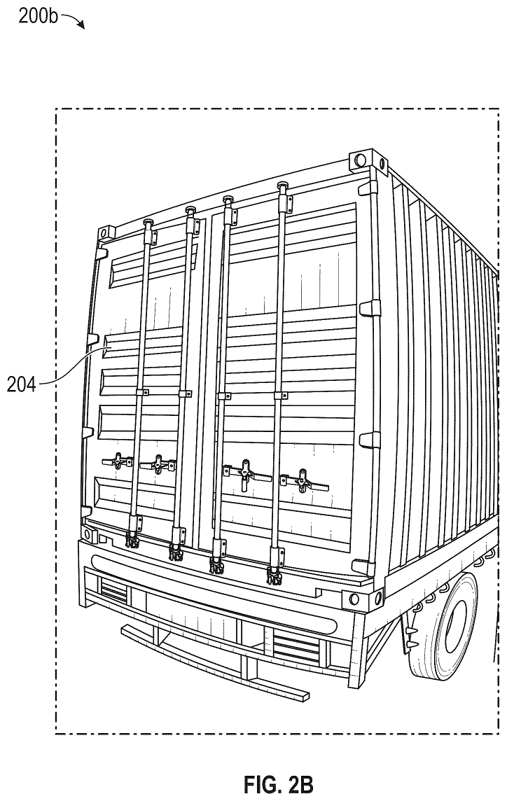

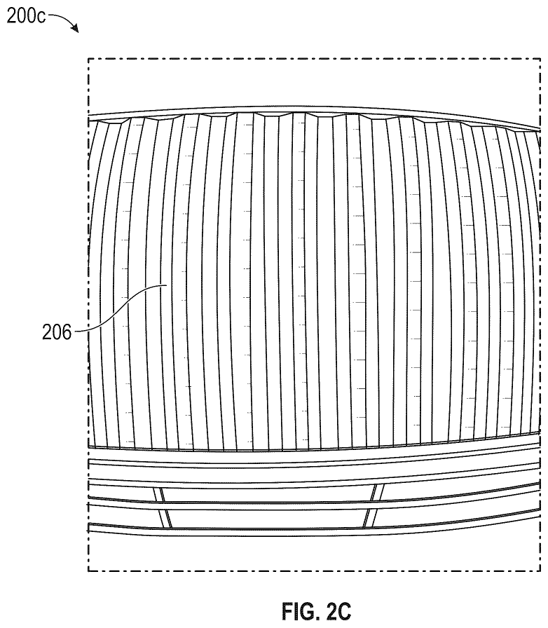

Referring to FIG. 2A, FIG. 2B, FIG. 2C, FIG. 2A, FIG. 2B, FIG. 2C are example diagrams 200a, 200b and 200c are depicting a front view of the container, a rear view of the container, and a side view of the container, in accordance with one or more exemplary embodiments. The diagram 200a includes a front view of the container 202. The front view of the container 202 may be captured by the first camera 102a. The diagram 200b depicts a rear view of the container 204. The rear view of the container 204 may be captured by the second camera 102b. The diagram 200c depicts a side view of the container 206. The side view of the container 206 may be captured by the third camera 102c.

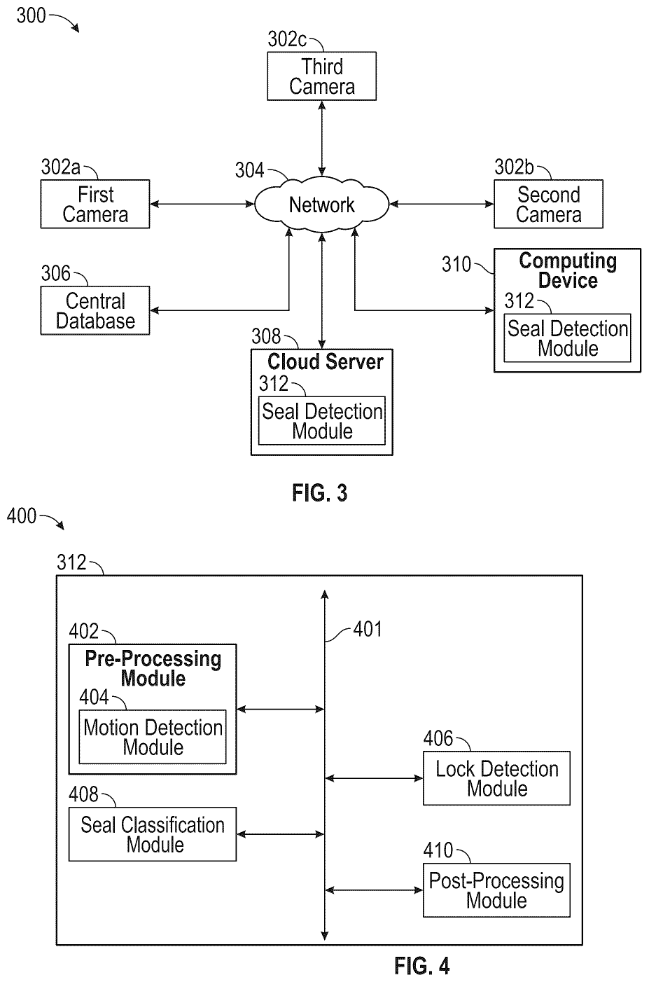

Referring to FIG. 3, FIG. 3 is a block diagram 300 representing a system in which aspects of the present disclosure can be implemented. Specifically, FIG. 3 depicts a schematic representation of the system for detecting presence and intactness of container seals, in accordance with one or more exemplary embodiments. The diagram 300 includes the first camera 302a, the second camera 302b, and the third camera 302c, a network 304, a central database 306, a cloud server 308 and a computing device 310. The computing device 310 includes a seal detection module 312. The network 304 may include, but is not limited to, an Ethernet, a wireless local area network (WLAN), or a wide area network (WAN), a Bluetooth low energy network, a ZigBee network, a Controller Area Network (CAN bus), a WIFI communication network e.g., the wireless high speed internet, or a combination of networks, a cellular service such as a 4G (e.g., LTE, mobile WiMAX) or 5G cellular data service, a RFID module, a NFC module, wired cables, such as the world-wide-web based Internet, or other types of networks may include Transport Control Protocol/Internet Protocol (TCP/IP) or device addresses (e.g. network-based MAC addresses, or those provided in a proprietary networking protocol, such as Modbus TCP, or by using appropriate data feeds to obtain data from various web services, including retrieving XML data from an HTTP address, then traversing the XML for a particular node) and the like without limiting the scope of the present disclosure.

Although the computing device 310, are shown in FIG. 3, an embodiment of the system 300 may support any number of computing devices. The computing device 310 may include, but is not limited to, a desktop computer, a personal mobile computing device such as a tablet computer, a laptop computer, or a netbook computer, a smartphone, a server, an augmented reality device, a virtual reality device, a digital media player, a piece of home entertainment equipment, backend servers hosting database 306 and other software, and the like. Each computing device 310 supported by the system 300 is realized as a computer-implemented or computer-based device having the hardware or firmware, software, and/or processing logic needed to carry out the intelligent messaging techniques and computer-implemented methodologies described in more detail herein.

The seal detection module 312 may be downloaded from the cloud server 308. For example, the seal detection module 312 may be any suitable application downloaded from, GOOGLE PLAY® (for Google Android devices), Apple Inc.'s APP STORE® (for Apple devices, or any other suitable database). In some embodiments, the seal detection module 312 may be software, firmware, or hardware that is integrated into the computing device 310. The seal detection module 312 which is accessed as mobile applications, web applications, software that offers the functionality of accessing mobile applications, and viewing/processing of interactive pages, for example, are implemented in the computing device 310 as will be apparent to one skilled in the relevant arts by reading the disclosure provided herein.

The computing device 310 may be configured to receive the first camera feed, second camera feed and the third camera feed as an input over the network 304. The computing device 310 includes the seal detection module 312 configured to detect the presence and intactness of the seals from the input images. The input images may include the multiple frames. The seal detection module 312 may be configured to monitor first camera feed, the second camera feed and the third camera feed continuously in independent threads and enables to save one or more frames when the motion of the vehicle is detected. The seal detection module 312 may be configured to detect the seals irrespective to an orientation of the container on the vehicle captured by the first camera 302a and the second camera 302b. The system 300 further includes RFID readers and machine-readable code readers configured to recognize a seal number. The seal detection module 312 may be also configured to detect seal color using an activation map of the classification model and histograms. Activation maps are just a visual representation of activation numbers at various layers of the network.

Referring to FIG. 4, FIG. 4 is an example diagram 400 depicting a schematic representation of a seal detection module, in accordance with one or more exemplary embodiments. The diagram 400 includes a bus 401, a seal detection module 312, a pre-processing module 402, a motion detection module 404, a lock detection module 406, a seal classification module 408, and a post-processing module 410. The pre-processing module 402 may be configured to receive the third camera feed as an input and save images when the truck starts crossing the third camera view. The third camera feed may include the side view images of the container.

The pre-processing module 402 includes a motion detection module 404 may be configured to compare consecutive frames of the third camera 102c to detect motion using frame difference. The pre-processing module 402 may be configured to save one or more consecutive frames from the first camera 302a and the second camera 302b when the vehicle starts crossing the third camera 302c. The first camera feed, the second camera feed and the third camera feed may be continuously monitored in independent threads but saving of frames is not performed until there is any motion detected. However, the entire image is not considered for comparison. Selected regions of interest from two consecutive frames are compared and the difference is computed using computer vision methods (For example, Structural Similarity Index Measure (SSIM) or absolute difference). The motion is considered to be detected whenever there is a significant difference between two consecutive frames.

The third camera 102c may be configured to detect motion as the third camera 102c is perpendicular to the container passing through the truck lane 105 so there may be a motion detection when the container passes through the third camera field of view. There are possibilities for false positives in the computations of the motion detection module 404. The resulting sequences due to false positives in the motion detection module 404 may be filtered using a threshold for the number of detections in the complete sequence. Discarding that particular instance if the number of detections is less than the threshold.

The lock detection module 406 includes a visual object detection module configured to receive the saved frames from the pre-processing module 402 as an input and detect the locks if present in the saved frames of the first and second cameras 102a and 102b. The lock detection module 406 may be configured to detect the presence of the lock and transmit the lock image to the seal classification module 408. The lock detection module 406 may be configured to remove a small portion of pixels at the top of the one or more images for the detection of one or more locks thereby improving the accuracy of the lock detection module 406 for detecting the locks.

The lock detection module 406 may fail to detect the locks few times due to the small size of the locks 103. To improve the accuracy of the lock detection module 406 for detecting the locks 103, removing a small portion of pixels at the top of the frame for lock detection as the locks 103 are always present on the lower right part of the container.

The seal classification module 408 may be configured to receive the lock images from the lock detection module 406 as an input and classifies the lock image to identify whether the lock is sealed or not. The seal classification module 408 may be configured to determine the seal intactness from the lock images by generating attention maps. The attention maps may be used to obtain better localization of the seal. The seal classification module 408 may include a computer vision and neural network methods configured to determine the color and intactness of the seal on obtaining the exact location of the seal.

The seal classification module 408 may be configured to determine the color of the seals by extracting the attention region and observing the pixel values in the extracted region. Further, after performing the seal classification on locks using seal classification module 408, the seal information is passed to the post-processing module 410 as a JavaScript Object Notation (JSON) file with a frame number. The seal information may include, but is not limited to, the number of seals present along with probability and also features with respect to seal are also saved into it, the color of the seals, seal intactness, and so forth. The post-processing module 410 may be configured to receive all the JavaScript Object Notation (JSON) files corresponding to the container and track each seal separately using a DeepSort tracking model. There is a possibility that sometimes the seal classification module 408 may infer incorrect prediction, hence, generating the final output by considering an averaged result over multiple frame outputs. The motion detection module 404 may be configured to filter the noise by averaging the observations over multiple consecutive frames.

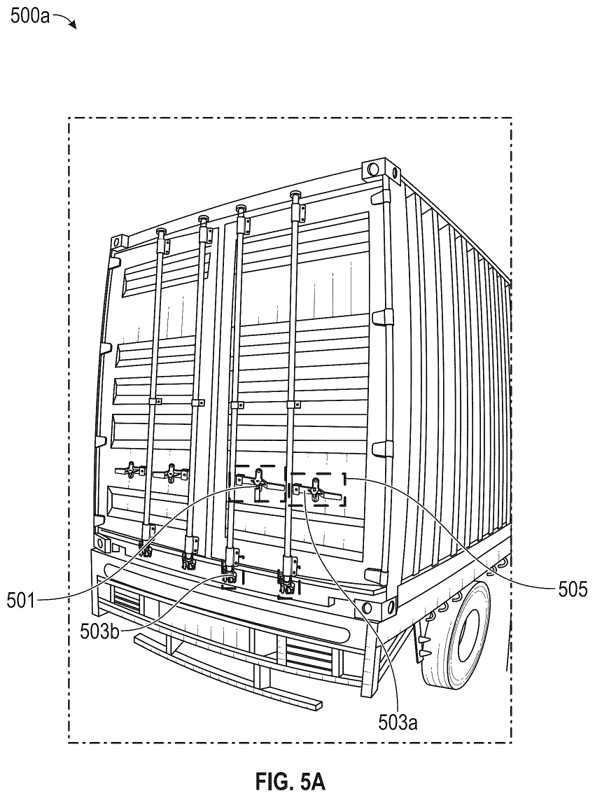

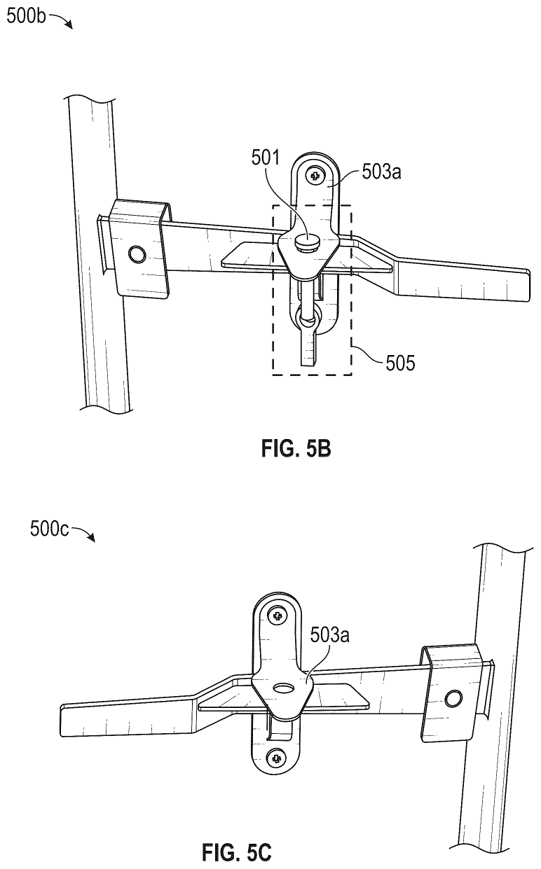

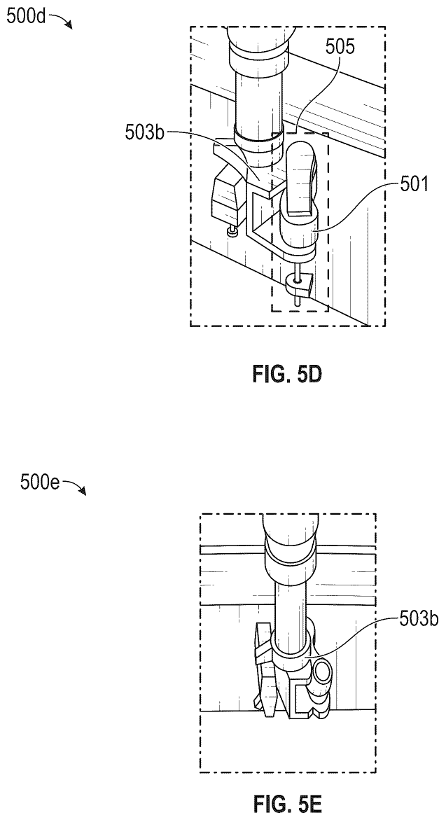

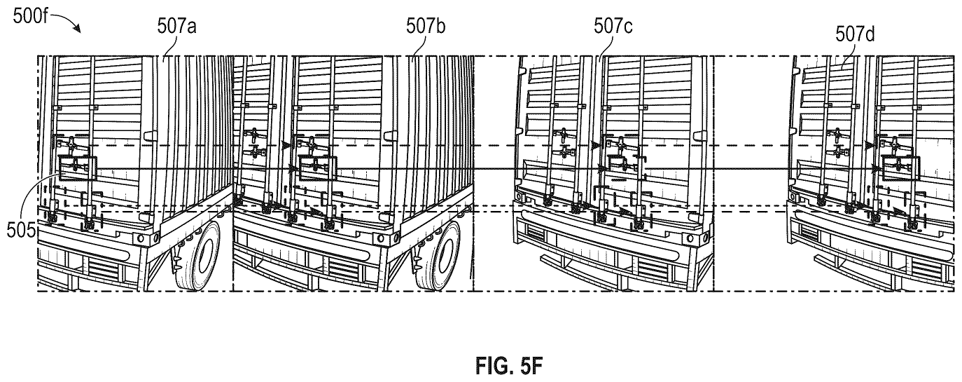

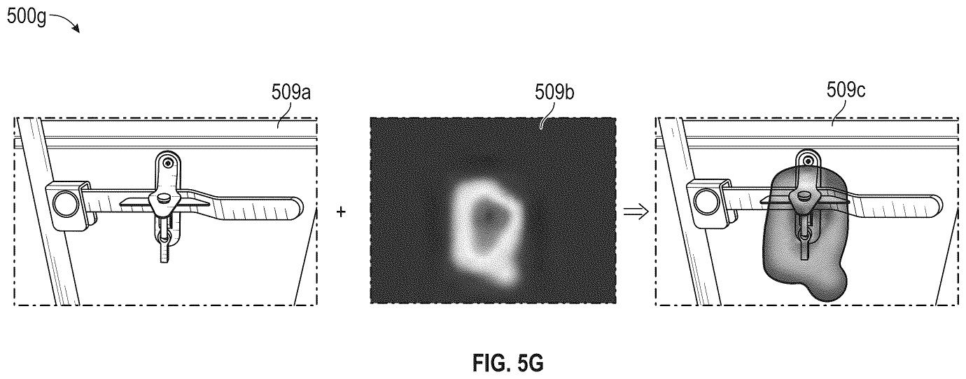

Referring to FIG. 5A, FIG. 5A is an example diagram 500a depicting the lock locations with bounding boxes, in accordance with one or more exemplary embodiments. The diagram 500a depicts the seal 501, a top lock 503a, a bottom lock 503b, and bounding boxes 505. The seals 501 are present on both the top locks 503a but there may be a chance of mounting the seals on the bottom locks 503b. The bounding boxes 505 may be configured to depict the lock locations on the container.

Referring to FIG. 5B, FIG. 5C, FIG. 5B, FIG. 5C are example diagrams 500b and 500c depicting the top lock view with and without seal, in accordance with one or more exemplary embodiments. The diagram 500b depicts the seal 501, and the top locks 503a. The top locks 503a are mounted with the seal 501. The diagram 500c depicts the top locks 503a. The top locks 503a may not be mounted with the seal 501.

Referring to FIG. 5D, FIG. 5E, FIG. 5D, FIG. 5E are example diagrams 500d and 500e depicting the bottom lock view with and without seal, in accordance with one or more exemplary embodiments. The diagram 500d depicts the seal 501, the bottom locks 503b. The bottom locks 503b may be mounted with the seal 501. The diagram 500e depicts the bottom locks 503b. The bottom locks 503b not mounted with the seal 501.

Referring to FIG. 5F, FIG. 5F, is an example diagram 500f depicting the seal tracking image, in accordance with one or more exemplary embodiments. The diagram 500d depicts the rear view of the container 204 (shown in FIG. 2B), bonding boxes 505, and multiple frames 507a, 507b, 507c and 507d. The seal of the same color is tracked over multiple frames 507a, 507b, 507c and 507d. The multiple frames 507a, 507b, 507c, and 507d may be captured from the first camera 302a or the second camera 302b.

Referring to FIG. 5G, FIG. 5G is an example diagram 500g depicting attention map image, in accordance with one or more exemplary embodiments. The diagram 500g depicts a seal image 509a, attention map 509b, and merged output 509c. The attention map 509b may be used for better localization of the seal, the seal classification module 408 comprising a computer vision and neural network methods configured to determine the color and seal intactness on obtaining the exact location of the seal. The seal image 509a, the attention map 509b may be combined to get the merged output 509c.

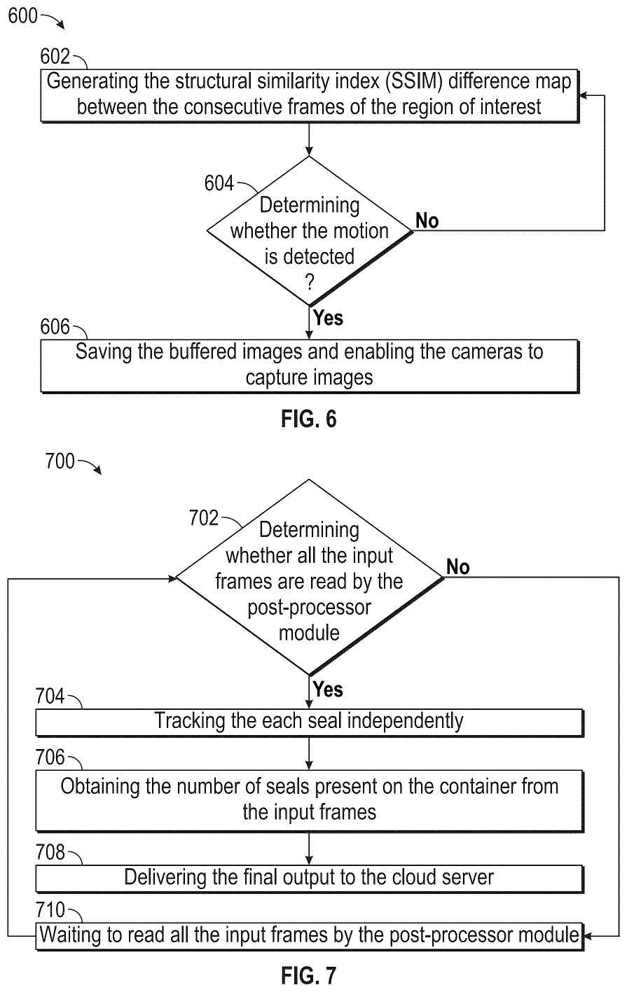

Referring to FIG. 6, FIG. 6 is an example flow diagram 600 depicting a method of the pre-processing module, in accordance with one or more exemplary embodiments. The method 600 may be carried out in the context of the details of FIG. 1A, FIG. 1B, FIG. 1C, FIG. 2A, FIG. 2B, FIG. 2C, FIG. 3, FIG. 4, FIG. 5A, FIG. 5B, FIG. 5C, FIG. 5D, and FIG. 5E. However, the method 600 may also be carried out in any desired environment. Further, the aforementioned definitions may equally apply to the description below.

The method commences at step 602, generating the structural similarity index (SSIM) difference map between the consecutive frames of the region of interest. Determining whether the motion is detected? at step 604. If the answer at step 604 is Yes, saving the buffered images and enabling the cameras to capture images, at step 606. If the answer at step 604 is No, the method reverts at step 602.

Referring to FIG. 7, FIG. 7 is another example of flow diagram 700 depicting a method of the post-processing module, in accordance with one or more exemplary embodiments. The method 700 may be carried out in the context of the details of FIG. 1A, FIG. 1B, FIG. 1C, FIG. 2A, FIG. 2B, FIG. 2C, FIG. 3, FIG. 4, FIG. 5A, FIG. 5B, FIG. 5C, FIG. 5D, FIG. 5E, and FIG. 6. However, the method 700 may also be carried out in any desired environment. Further, the aforementioned definitions may equally apply to the description below.

The method commences at step 702, determining whether all the input frames are read by the post-processing module? If the answer at step 702 is Yes, tracking each seal independently, at step 704. Thereafter at step 706, obtaining the number of seals present on the container from the input frames. Thereafter at step 708, delivering the final output to the cloud server. If the answer at step 702 is No, waiting to read all the input frames by the post-processing module, at step 710. Thereafter at step 710, the method reverts at step 702.

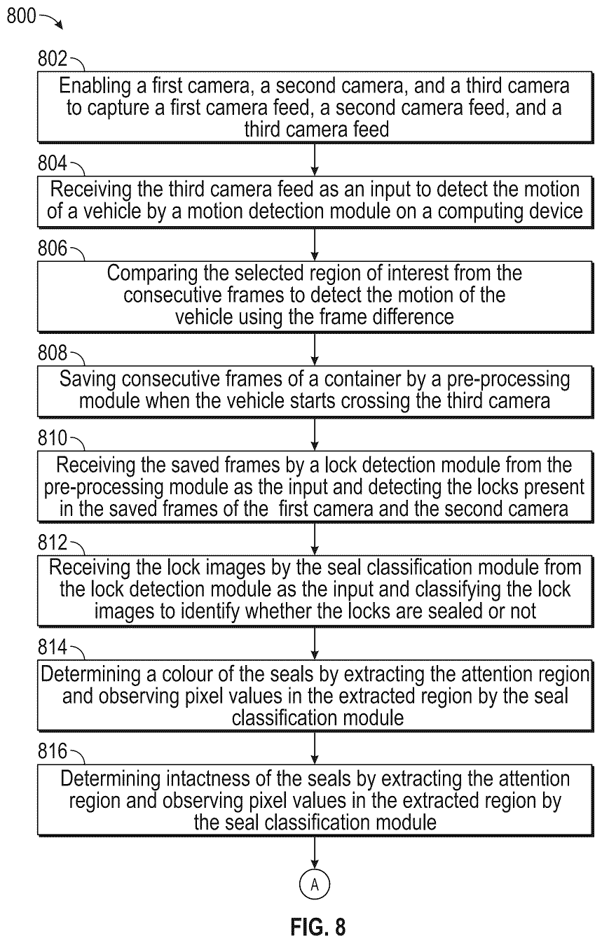

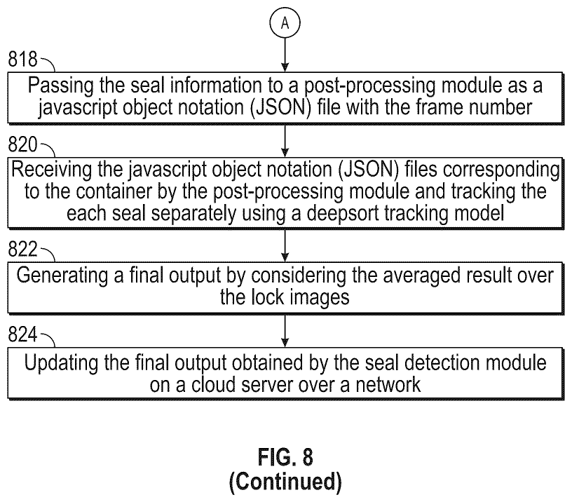

Referring to FIG. 8, FIG. 8 is another example of flow diagram 800 depicting a method for detecting presence and intactness of one or more seals of a container, in accordance with one or more exemplary embodiments. The method 700 may be carried out in the context of the details of FIG. 1A, FIG. 1B, FIG. 1C, FIG. 2A, FIG. 2B, FIG. 2C, FIG. 3, FIG. 4, FIG. 5A, FIG. 5B, FIG. 5C, FIG. 5D, FIG. 5E, FIG. 6 and FIG. 7. However, the method 800 may also be carried out in any desired environment. Further, the aforementioned definitions may equally apply to the description below.

The method commences at step 802, enabling the first camera, the second camera, and the third camera to capture the first camera feed, the second camera feed, and the third camera feed. Thereafter at step 804, receiving the third camera feed as the input to detect the motion of the vehicle by the motion detection module on the computing device. Thereafter at step 806, comparing the selected region of interest from the one or more consecutive frames to detect motion of the vehicle using the frame difference. Thereafter at step 808, saving the consecutive frames of the container by the pre-processing module when the vehicle starts crossing the third camera. Thereafter at step 810, receiving the saved frames by the lock detection module from the pre-processing module as an input and detecting the locks present in the saved frames of the first camera and the second camera. Thereafter at step 812, receiving the lock images by the seal classification module from the lock detection module as the input and classifying the lock images to identify whether the locks are sealed or not. Thereafter at step 814, determining a color of the seals by extracting the attention region and observing pixel values in the extracted region by the seal classification module. Thereafter at step 816, determining intactness of the seals by extracting the attention region and observing pixel values in the extracted region by the seal classification module. Thereafter at step 818, passing the seal information to the post-processing module as a JavaScript Object Notation (JSON) file with the frame number. Thereafter at step 820, receiving the JavaScript Object Notation (JSON) files corresponding to the container by the post-processing module and tracking the each seal separately using a DeepSort tracking model. Thereafter at step 822, generating the final output by considering the averaged result over the lock images. Thereafter at step 828, updating the final output obtained by the seal detection module on the cloud server over the network, the final output comprising number of seals identified on the locks of the container.

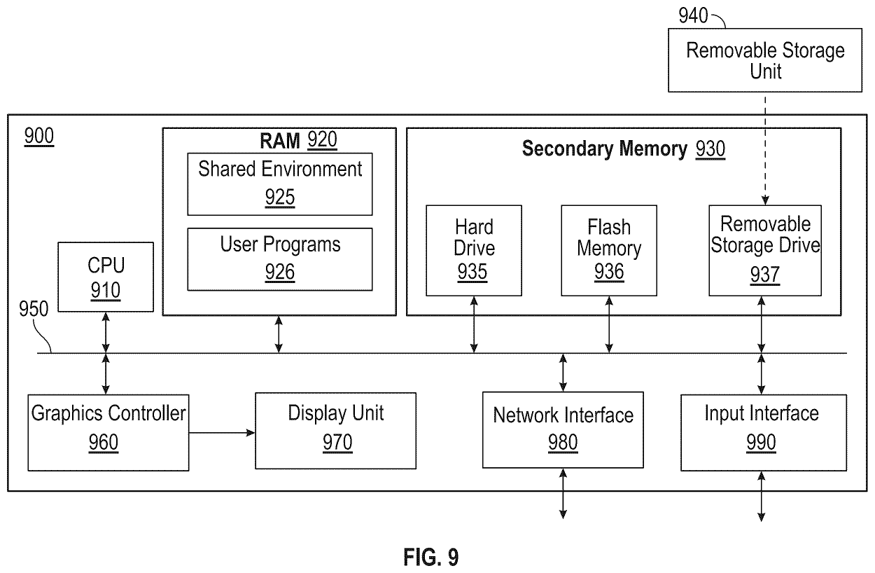

Referring to FIG. 9, FIG. 9 is a block diagram illustrating the details of digital processing system 900 in which various aspects of the present disclosure are operative by execution of appropriate software instructions. Digital processing system 900 may correspond to the computing device 310 (or any other system in which the various features disclosed above can be implemented).

Digital processing system 900 may contain one or more processors such as a central processing unit (CPU) 910, random access memory (RAM) 920, secondary memory 930, graphics controller 960, display unit 970, network interface 980, an input interface 990. All the components except display unit 970 may communicate with each other over communication path 950, which may contain several buses as is well known in the relevant arts. The components of FIG. 9 are described below in further detail.

CPU 910 may execute instructions stored in RAM 920 to provide several features of the present disclosure. CPU 910 may contain multiple processing units, with each processing unit potentially being designed for a specific task. Alternatively, CPU 910 may contain only a single general-purpose processing unit.

RAM 920 may receive instructions from secondary memory 930 using communication path 950. RAM 920 is shown currently containing software instructions, such as those used in threads and stacks, constituting shared environment 925 and/or user programs 926. Shared environment 925 includes operating systems, device drivers, virtual machines, etc., which provide a (common) run time environment for execution of user programs 926.

Graphics controller 960 generates display signals (e.g., in RGB format) to display unit 970 based on data/instructions received from CPU 910. Display unit 970 contains a display screen to display the images defined by the display signals. Input interface 990 may correspond to a keyboard and a pointing device (e.g., touch-pad, mouse) and may be used to provide inputs. Network interface 980 provides connectivity to a network (e.g., using Internet Protocol), and may be used to communicate with other systems (such as those shown in FIG. 3, a network 304) connected to the network 304.

Secondary memory 930 may contain hard drive 935, flash memory 936, and removable storage drive 937. Secondary memory 930 may store the data software instructions (e.g., for performing the actions noted above with respect to the Figures), which enable digital processing system 900 to provide several features in accordance with the present disclosure.

Some or all of the data and instructions may be provided on the removable storage unit 940, and the data and instructions may be read and provided by removable storage drive 937 to CPU 910. Floppy drive, magnetic tape drive, CD-ROM drive, DVD Drive, Flash memory, a removable memory chip (PCMCIA Card, EEPROM) are examples of such removable storage drive 937.

The removable storage unit 940 may be implemented using medium and storage format compatible with removable storage drive 937 such that removable storage drive 937 can read the data and instructions. Thus, removable storage unit 940 includes a computer readable (storage) medium having stored therein computer software and/or data. However, the computer (or machine, in general) readable medium can be in other forms (e.g., non-removable, random access, etc.).

In this document, the term “computer program product” is used to generally refer to the removable storage unit 940 or hard disk installed in hard drive 935. These computer program products are means for providing software to digital processing system 900. CPU 910 may retrieve the software instructions, and execute the instructions to provide various features of the present disclosure described above.

The term “storage media/medium” as used herein refers to any non-transitory media that store data and/or instructions that cause a machine to operate in a specific fashion. Such storage media may comprise non-volatile media and/or volatile media. Non-volatile media includes, for example, optical disks, magnetic disks, or solid-state drives, such as storage memory 930. Volatile media includes dynamic memory, such as RAM 920. Common forms of storage media include, for example, a floppy disk, a flexible disk, hard disk, solid-state drive, magnetic tape, or any other magnetic data storage medium, a CD-ROM, any other optical data storage medium, any physical medium with patterns of holes, a RAM, a PROM, and EPROM, a FLASH-EPROM, NVRAM, any other memory chip or cartridge.

Storage media is distinct from but may be used in conjunction with transmission media. Transmission media participates in transferring information between storage media. For example, transmission media includes coaxial cables, copper wire and fiber optics, including the wires that comprise bus 950. Transmission media can also take the form of acoustic or light waves, such as those generated during radio-wave and infra-red data communications.

In another embodiment of the present disclosure, a pre-processing module 402 comprising a motion detection module 404 configured to receive the third camera feed as an input to detect the motion of a vehicle.

In another embodiment of the present disclosure, the motion detection module 404 configured to compare a selected region of interest from the one or more consecutive frames of the third camera 302c to detect motion of the vehicle using a frame difference.

In another embodiment of the present disclosure, the pre-processing module 402 configured to save one or more consecutive frames from the first camera 302a and the second camera 302b when the vehicle starts crossing the third camera 302c.

In another embodiment of the present disclosure, the frame difference is computed using one or more computer vision methods, the third camera 302c configured to detect motion of the vehicle, the third camera 302c is positioned perpendicular to the container passing through a vehicle lane, the first camera 302a is positioned front side to the container passing through the vehicle lane and the second camera 302b is positioned rear side to the container passing through the vehicle lane.

In another embodiment of the present disclosure, a lock detection module 406 comprising a visual object detection module configured to receive the one or more saved frames from the pre-processing module 402 as the input and detect one or more locks present in the one or more saved frames of the first camera 302a and the second camera 302b.

In another embodiment of the present disclosure, a seal classification module 408 configured to receive the one or more lock images from the lock detection module 406 as the input and classify the one or more lock images to identify whether the one or more locks are sealed.

In another embodiment of the present disclosure, the seal classification module 408 configured to determine a color of the one or more container seals by extracting an attention region and observing one or more pixel values in the extracted region using the activation map of a classification model and histograms.

In another embodiment of the present disclosure, the seal classification module 408 configured to determine intactness of the one or more container seals by extracting an attention region and observing one or more pixel values in the extracted region.

In another embodiment of the present disclosure, the seal classification module 408 configured to determine the color and the seal intactness from the one or more lock images by generating one or more attention maps, the one or more attention maps are used to obtain better localization of the seal, the seal classification module 408 comprising a computer vision and neural network methods configured to determine the color and the seal intactness on obtaining the exact location of the seal.

In another embodiment of the present disclosure, the seal classification module 408 configured to pass seal information to a post-processing module 410 as a JavaScript Object Notation (JSON) file with a frame number.

In another embodiment of the present disclosure, the post-processing module 408 configured to receive the JavaScript Object Notation (JSON) files corresponding to the container and tracks at least one seal separately using a DeepSort tracking model thereby generating a final output by considering an averaged result over the one or more lock images.

In another embodiment of the present disclosure, a cloud server 308 configured to receive a final output from the seal detection module 312 over the network 304 and updates the final output obtained by the seal detection module 312 on the cloud server 308, the final output comprising number of seals identified on the one or more locks of the container.

Reference throughout this specification to “one embodiment”, “an embodiment”, or similar language means that a particular feature, structure, or characteristic described in connection with the embodiment is included in at least one embodiment of the present disclosure. Thus, appearances of the phrases “in one embodiment”, “in an embodiment” and similar language throughout this specification may, but do not necessarily, all refer to the same embodiment.

Furthermore, the described features, structures, or characteristics of the disclosure may be combined in any suitable manner in one or more embodiments. In the above description, numerous specific details are provided such as examples of programming, software modules, user selections, network transactions, database queries, database structures, hardware modules, hardware circuits, hardware chips, etc., to provide a thorough understanding of embodiments of the disclosure.

Although the present disclosure has been described in terms of certain preferred embodiments and illustrations thereof, other embodiments and modifications to preferred embodiments may be possible that are within the principles and spirit of the invention. The above descriptions and figures are therefore to be regarded as illustrative and not restrictive.

Thus the scope of the present disclosure is defined by the appended claims and includes both combinations and sub-combinations of the various features described hereinabove as well as variations and modifications thereof, which would occur to persons skilled in the art upon reading the foregoing description.

1. A system for detecting presence and intactness of one or more seals on a container, comprising:
a first camera, a second camera, and a third camera configured to detect motion of a vehicle and enable to capture a first camera feed, a second camera feed, and a third camera feed, and deliver the first camera feed, the second camera feed and the third camera feed to a computing device over a network, whereby the computing device comprising a seal detection module configured to detect presence and intactness of one or more seals on a container using an activation map;
a pre-processing module comprising a motion detection module configured to receive the third camera feed as an input to detect the motion of a vehicle, the motion detection module configured to compare a selected region of interest from the one or more consecutive frames of the third camera to detect motion of the vehicle using a frame difference, the pre-processing module configured to save one or more consecutive frames from the first camera and the second camera when the vehicle starts crossing the third camera, whereby the frame difference is computed using one or more computer vision methods, the third camera configured to detect motion of the vehicle, the third camera is positioned perpendicular to the container passing through a vehicle lane, the first camera is positioned front side to the container passing through the vehicle lane and the second camera is positioned rear side to the container passing through the vehicle lane;
a lock detection module comprising a visual object detection module configured to receive the one or more saved frames from the pre-processing module as the input and detect one or more locks present in the one or more saved frames of the first camera and the second camera, the lock detection module configured to detect the presence of the one or more locks and transmit the one or more lock images to a seal classification module;
whereby the seal classification module configured to receive the one or more lock images from the lock detection module as the input and classify the one or more lock images to identify whether the one or more locks are sealed, the seal classification module configured to determine a color of the one or more container seals by extracting an attention region and observing one or more pixel values in the extracted region using the activation map of a classification model and histograms, the seal classification module configured to determine intactness of the one or more container seals by extracting an attention region and observing one or more pixel values in the extracted region, the seal classification module configured to determine the color and the seal intactness from the one or more lock images by generating one or more attention maps, the one or more attention maps are used to obtain better localization of the seal, the seal classification module comprising a computer vision and neural network methods configured to determine the color and the seal intactness on obtaining the exact location of the seal;
the seal classification module configured to pass seal information to a post-processing module as a JavaScript Object Notation (json) file with a frame number;
the post-processing module configured to receive the JavaScript Object Notation (JSON) files corresponding to the container and tracks at least one seal separately using a DeepSort tracking model thereby generating a final output by considering an averaged result over the one or more lock images; and
a cloud server configured to receive a final output from the seal detection module over the network and updates the final output obtained by the seal detection module on the cloud server, the final output comprising number of seals identified on the one or more locks of the container.

2. The system of claim 1, wherein the third camera feed comprising one or more side view images of the container.

3. The system of claim 1, wherein the seal detection module is configured to monitor the first camera feed, the second camera feed, and the third camera feed continuously in independent threads and enables to save one or more images when the motion of the vehicle is detected.

4. The system of claim 1, wherein the motion detection module is configured to filter the noise by averaging the observations over multiple consecutive frames.

5. The system of claim 1, wherein the post-processing module is configured to filter the one or more false positives using a threshold for the number of detections in a complete sequence.

6. The system of claim 1, wherein the lock detection module is configured to remove a small portion of pixels at the top of the one or more images for the detection of one or more locks thereby improving the accuracy of the lock detection module for detecting the locks.

7. The system of claim 1, wherein the seal information comprising the number of seals present, the color of the seals, and the intactness of the seals.

8. The system of claim 1, wherein the seal detection module is configured to detect the one or more seals irrespective to an orientation of the container on the vehicle captured by the first camera and the second camera.

9. The system of claim 1, comprising one or more RFID readers and a machine-readable code reader are configured to recognize a seal number.

10. A method for detecting presence and intactness of one or more seals on a container, comprising:
enabling a first camera, a second camera, and a third camera to capture a first camera feed, a second camera feed, and a third camera feed;
receiving the third camera feed as an input to detect the motion of the vehicle by a motion detection module on a computing device;
comparing a selected region of interest from the one or more consecutive frames by a motion detection module to detect motion of the vehicle using a frame difference;
saving one or more consecutive frames from the first camera and the second camera by the pre-processing module when the vehicle starts crossing the third camera;
receiving the one or more saved frames by a lock detection module from the pre-processing module as an input and detecting one or more locks present in the one or more saved frames of the first camera and the second camera;
receiving the one or more lock images by the seal classification module from the lock detection module as an input and classifying the one or more lock images to identify whether the one or more locks are sealed;
determining a color of the one or more seals by extracting an attention region and observing one or more pixel values in the extracted region by the seal classification module;
determining intactness of the one or more seals by extracting an attention region and observing one or more pixel values in the extracted region by the seal classification module;
passing the seal information to a post-processing module as a JavaScript Object Notation (json) file with a frame number;
receiving the JavaScript Object Notation (json) files corresponding to the container by the post-processing module and tracking each seal separately using a DeepSort tracking model;
generating a final output by considering an averaged result over the one or more lock images; and
updating the final output obtained by the seal detection module on a cloud server over a network, the final output comprising number of seals identified on the one or more locks of the container.

11. The method of claim 10, further comprising a step of monitoring the first camera feed, the second camera feed and the third camera feed continuously in independent threads and enabling to save one or more images when the motion of the vehicle is detected.

12. The method of claim 10, further comprising a step of filtering the noise by averaging the observations over multiple consecutive frames using the motion detection module.

13. The method of claim 10, further comprising a step of filtering the one or more false positives by the post-processing module using a threshold for the number of detections in a complete sequence.

14. The method of claim 10, further comprising a step of removing a small portion of pixels at the top of the one or more images for the detection of one or more locks thereby improving the accuracy of the lock detection module for detecting the one or more locks.

15. The method of claim 10, further comprising a step of detecting the one or more seals by the seal detection module irrespective to an orientation of the container on the vehicle captured by the first camera and the second camera.

16. The method of claim 10, further comprising a step of determining the seal intactness from the one or more lock images by generating one or more attention maps using the seal classification module.

17. The method of claim 16, further comprising a step of obtaining better localization of the seal using the one or more attention maps.

18. The method of claim 10, further comprising a step of determining the color and seal intactness using a computer vision and neural network methods on obtaining the exact location of the seal.
